(19) United States
(12) Patent Application Publication
(10) Pub. No.: US 2026/0178644 A1
(43) Pub. Date: Jun. 25, 2026

(54) INFORMATION PROCESSING SYSTEM AND INFORMATION PROCESSING METHOD

(71) Applicant: Semiconductor Energy Laboratory Co., Ltd., Atsugi-shi (JP)

(72) Inventors: Junpei MOMO, Sagamihara (JP); Kazuki HIGASHI, Atsugi (JP)

(21) Appl. No.: 19/410,154

(22) Filed: Dec. 5, 2025

(30) Foreign Application Priority Data
Dec. 20, 2024 (JP) 2024-225325

(51) Int. Cl. G06F 16/34; G06F 40/169

(52) U.S. Cl. CPC G06F 16/345; G06F 40/169

(57) ABSTRACT

A novel information processing system comprising first to third components is provided. The first component has a function of receiving various kinds of data and providing it. The second component has a function of generating a list or a document in accordance with a prompt with the use of a multimodal AI server. The third component has a function of receiving the various kinds of data and sharing it and a function of transmitting the prompt. The third component includes four subcomponents. A first subcomponent has a function of dividing moving image information to create a group of chunk data. A second subcomponent has a function of transcribing audio information. A third subcomponent has a function of storing the group of chunk data and a function of creating an annotated document using a database and a management system. A fourth subcomponent has a function of creating the prompt.

### BACKGROUND OF THE INVENTION

### 1. Field of the Invention

One embodiment of the present invention relates to an information processing system, an information processing method, or a semiconductor device.

Note that one embodiment of the present invention is not limited to the above technical field. The technical field of one embodiment of the invention disclosed in this specification and the like relates to an object, a method, or a manufacturing method. One embodiment of the present invention relates to a process, a machine, manufacture, or a composition of matter. Thus, more specifically, examples of the technical field of one embodiment of the present invention disclosed in this specification include an information processing device, a semiconductor device, a memory device, a driving method thereof, and a manufacturing method thereof.

### 2. Description of the Related Art

In recent years, language models using neural networks have been actively developed, and especially large language models (LLM) have attracted attention. An large language model is a natural language processing model learned using a large amount of data. With a large language model, for example, a communication model that gives an answer to a user's instruction can be achieved. In Non-Patent Document 1, generative pre-trained transformer 4 (GPT-4, registered trademark) is disclosed as a large language model, and ChatGPT is disclosed as a communication model.

By utilizing a large language model, the capability of a natural language processing model has been significantly increased. On the other hand, owing to the expansion of the language model, it is difficult to incorporate and operate a language model on one's own from the aspect of facilities and costs. Accordingly, utilizing an external service that provides a language model is one of the utility forms of a language model. Furthermore, language models are advancing towards multimodal capabilities, generating language that incorporates the interpretation of image information. Such models that handle not only language but also other information are also referred to as multimodal models or foundation models.

### Reference

[Non-Patent Document 1] Summary of ChatGPT/GPT-4 Research and Perspective Towards the Future of Large Language Models, Yiheng Liu et al., (submitted on 4 Apr., 2023) [online], Internet URL: https://arxiv.org/abs/2304.01852

### SUMMARY OF THE INVENTION

It is conventionally known that audio data can be transcribed by being converted into text data via speech recognition technique. For example, audio data obtained from video data of a conference or the like is transcribed so that a conversation record or the like can be generated. However, information obtained by transcription sometimes includes a large number of demonstratives whose referents are unspecified. In such a case, the information obtained by transcription alone may be insufficient as a record such as a conversation record.

In view of the above problem, an object of one embodiment of the present invention is to provide an information processing system for supporting document preparation by supplementing the referent of a demonstrative whose referent is unspecified in a conversation record or the like. Another object is to provide a novel information processing system that is highly convenient, useful, or reliable. Another object is to provide a novel information processing method that is highly convenient, useful, or reliable. Another object is to provide a novel information processing system, a novel information processing method, or a novel semiconductor device.

Note that the description of these objects does not preclude the existence of other objects. One embodiment of the present invention does not need to achieve all these objects. Other objects will be apparent from and can be derived from the description of the specification, the drawings, the claims, and the like.

(1) One embodiment of the present invention is an information processing system including a first component, a second component, and a third component.

The first component has a function of receiving moving image information and transmitting it to the third component and a function of receiving an annotated document and providing it. The annotated document includes a first document created from the moving image information. The first document includes a demonstrative whose referent is unspecified and an annotation. The annotation includes information specified as a referent of the demonstrative whose referent is unspecified.

The second component has a function of receiving a first prompt and transmitting a list to the third component, a function of receiving a second prompt and transmitting the first document to the third component, and a function of performing processing with the use of a multimodal AI server. The multimodal AI server has a function of generating the list in accordance with the first prompt and a function of generating the first document in accordance with the second prompt.

The third component has a function of receiving the moving image information, the list, and the first document and sharing them in the third component, a function of transmitting the first prompt and the second prompt to the second component, and a function of transmitting the annotated document to the first component. The third component includes a first subcomponent, a second subcomponent, a third subcomponent, and a fourth subcomponent.

The first subcomponent has a function of dividing the moving image information to create a group of chunk data. The chunk data includes identification information, audio information, and a still image. The still image is an image that represents the chunk data.

The second subcomponent has a function of transcribing the audio information into a second document.

The third subcomponent includes a database and a management system. The database has a function of storing the group of chunk data. The management system has a function of integrating the first document into the chunk data and a function of creating the annotated document from the database.

The fourth subcomponent has a function of creating the first prompt and a function of sequentially selecting the identification information from the list to create the second prompt. The first prompt includes a first instruction and a first table. The first instruction includes a procedure for generating the list from the first table. The list includes the identification information that identifies the second document including the demonstrative whose referent is unspecified. The second prompt includes a second instruction, the second document, and the still image. The second instruction includes a procedure for specifying, from the still image, the referent of the demonstrative whose referent is unspecified included in the second document and generating the first document.

(2) Another embodiment of the present invention is the information processing system in which the third subcomponent has a function of sharing the first table and a second table in the third component.

The management system has a function of creating the first table and the second table from the database. The first table includes a first column and a second column. The first column includes the identification information. The second column includes the second document. The second table includes a third column, a fourth column, and a fifth column. The third column includes the identification information included in the list. The fourth column includes the second document. The fifth column includes the still image.

(3) Another embodiment of the present invention is the information processing system in which the first component has a function of receiving a summary document and providing it.

The second component has a function of receiving a third prompt and transmitting the summary document to the third component. The multimodal AI server has a function of generating the summary document in accordance with the third prompt.

The third component has a function of transmitting the third prompt to the second component and a function of receiving the summary document and transmitting it to the first component.

The fourth subcomponent has a function of creating the third prompt. The third prompt includes a third instruction and the annotated document. The third instruction includes a procedure for generating the summary document from the annotated document.

(4) Another embodiment of the present invention is the information processing system in which the first component has a function of receiving a task list and providing it.

The second component has a function of receiving a fourth prompt and transmitting the task list to the third component. The multimodal AI server has a function of generating the task list in accordance with the fourth prompt.

The third component has a function of transmitting the fourth prompt to the second component and a function of receiving the task list and transmitting it to the first component.

The fourth subcomponent has a function of creating the fourth prompt. The fourth prompt includes a fourth instruction and the annotated document. The fourth instruction includes a procedure for generating the task list from the annotated document.

(5) One embodiment of the present invention is an information processing method including a first phase. The first phase includes a first step to an eighteenth step.

In the first step of the first phase, a first component receives moving image information and transmits it to a second component. The second component includes a first subcomponent, a second subcomponent, a third subcomponent, and a fourth subcomponent. The third subcomponent includes a database and a management system.

In the second step of the first phase, the second component receives the moving image information and shares it in the second component.

In the third step of the first phase, the first subcomponent divides the moving image information to create a group of chunk data. The group of chunk data includes chunk data. The chunk data includes identification information, audio information, and a still image. The still image is an image that represents the chunk data.

In the fourth step of the first phase, the second subcomponent transcribes the audio information into a first document.

In the fifth step of the first phase, the third subcomponent integrates the first document into the chunk data with the use of the management system.

In the sixth step of the first phase, the management system creates a first table from the database and shares the first table in the second component. The first table includes a first column and a second column. The first column includes the identification information. The second column includes the first document.

In the seventh step of the first phase, the fourth subcomponent creates a first prompt and transmits it to a third component. The first prompt includes a first instruction and the first table. The first instruction includes a procedure for generating a list from the first table. The list includes the identification information that identifies the first document including a demonstrative whose referent is unspecified.

In the eighth step of the first phase, the third component receives the first prompt and generates the list with the use of a multimodal AI server.

In the ninth step of the first phase, the third component transmits the list to the second component.

In the tenth step of the first phase, the second component receives the list and shares it in the second component.

In the eleventh step of the first phase, the management system creates a second table from the database and shares the second table in the second component. The second table includes a third column, a fourth column, and a fifth column. The third column includes the identification information included in the list. The fourth column includes the first document. The fifth column includes the still image.

In the twelfth step of the first phase, the fourth subcomponent sequentially selects a record from the second table to create a second prompt and transmits it to the third component. The second prompt includes a second instruction, the first document, and the still image. The second instruction includes a procedure for specifying, from the still image, a referent of the demonstrative whose referent is unspecified included in the first document and generating a second document. The second document includes the demonstrative whose referent is unspecified and an annotation. The annotation includes information specified as the referent of the demonstrative whose referent is unspecified.

In the thirteenth step of the first phase, the third component receives the second prompt and generates the second document with the use of the multimodal AI server.

In the fourteenth step of the first phase, the third component transmits the second document to the second component.

In the fifteenth step of the first phase, the second component receives the second document and shares it in the second component.

In the sixteenth step of the first phase, the management system integrates the second document into the chunk data.

In the seventeenth step of the first phase, the management system creates an annotated document from the database and transmits it to the first component. The annotated document includes the second document created from the moving image information.

In the eighteenth step of the first phase, the first component receives the annotated document and provides it.

(6) Another embodiment of the present invention is the information processing method further including a second phase. The second phase follows the first phase. The second phase includes a first step to a sixth step.

In the first step of the second phase, the fourth subcomponent creates a third prompt and transmits it to the third component. The third prompt includes a third instruction and the annotated document. The third instruction includes a procedure for generating a summary document from the annotated document.

In the second step of the second phase, the third component receives the third prompt and generates the summary document with the use of the multimodal AI server.

In the third step of the second phase, the third component transmits the summary document to the second component.

In the fourth step of the second phase, the second component receives the summary document and shares it in the second component.

In the fifth step of the second phase, the second component transmits the summary document to the first component.

In the sixth step of the second phase, the first component receives the summary document and provides it.

(7) Another embodiment of the present invention is the information processing method further including a third phase. The third phase follows the first phase. The third phase includes a first step to a sixth step.

In the first step of the third phase, the fourth subcomponent creates a fourth prompt and transmits it to the third component. The fourth prompt includes a fourth instruction and the annotated document. The fourth instruction includes a procedure for generating a task list from the annotated document.

In the second step of the third phase, the third component receives the fourth prompt and generates the task list with the use of the multimodal AI server.

In the third step of the third phase, the third component transmits the task list to the second component.

In the fourth step of the third phase, the second component receives the task list and shares it in the second component.

In the fifth step of the third phase, the second component transmits the task list to the first component.

In the sixth step of the third phase, the first component receives the task list and provides it.

In view of the above problem, one embodiment of the present invention can provide an information processing system for supporting document preparation by supplementing the referent of a demonstrative whose referent is unspecified in a conversation record or the like. Alternatively a novel information processing system that is highly convenient, useful, or reliable can be provided. Alternatively, a novel information processing method that is highly convenient, useful, or reliable can be provided. Alternatively, a novel information processing system, a novel information processing method, or a novel semiconductor device can be provided.

Note that the description of these objects does not preclude the existence of other objects. One embodiment of the present invention does not need to achieve all these objects. Other objects will be apparent from and can be derived from the description of the specification, the drawings, the claims, and the like.

### BRIEF DESCRIPTION OF THE DRAWINGS

FIG. 1 illustrates a configuration example of an information processing system.

FIGS. 2A and 2B illustrate an example of moving image information related to an operation of the information processing system.

FIG. 3 illustrates a configuration example of a component related to the operation of the information processing system.

FIG. 4 illustrates the moving image information related to the operation of the information processing system.

FIGS. 5A and 5B are diagrams each illustrating chunk data related to the operation of the information processing system.

FIG. 6 illustrates a document related to the operation of the information processing system.

FIGS. 7A and 7B are diagrams each illustrating a generated table related to the operation of the information processing system.

FIG. 8A illustrates a configuration example of a prompt related to the operation of the information processing system. FIG. 8B illustrates a generated list related to the operation of the information processing system.

FIG. 9A illustrates a configuration example of a prompt related to the operation of the information processing system. FIG. 9B illustrates a document related to the operation of the information processing system.

FIGS. 10A and 10B are diagrams each illustrating a configuration example of a prompt related to the operation of the information processing system.

FIG. 11 is a block diagram illustrating a configuration example of an information processing device.

FIG. 12 is a flow diagram illustrating an example of an information processing method.

FIG. 13 is a flow diagram illustrating an example of an information processing method.

FIG. 14 is a flow diagram illustrating an example of an information processing method.

### DETAILED DESCRIPTION OF THE INVENTION

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Thus, the present invention should not be construed as being limited to the description in the following embodiments. Note that in structures of the invention described below, the same portions or portions having similar functions are denoted by the same reference numerals in different drawings, and the description thereof is not repeated.

Ordinal numbers such as “first” and “second” in this specification and the like are used in order to avoid confusion among components and thus do not limit the number of components or the order of components (e.g., the order of steps or the stacking order of layers). A term without an ordinal number in this specification and the like may be described with an ordinal number in a claim in order to avoid confusion among components. A term with an ordinal number in this specification and the like may be described with a different ordinal number in a claim. A term with an ordinal number in this specification and the like may be described without an ordinal number in a claim.

Although a block diagram in which components are classified by their functions and shown as independent blocks is shown in the drawing attached to this specification, it is difficult to completely separate actual components according to their functions and one component can relate to a plurality of functions.

### Embodiment 1

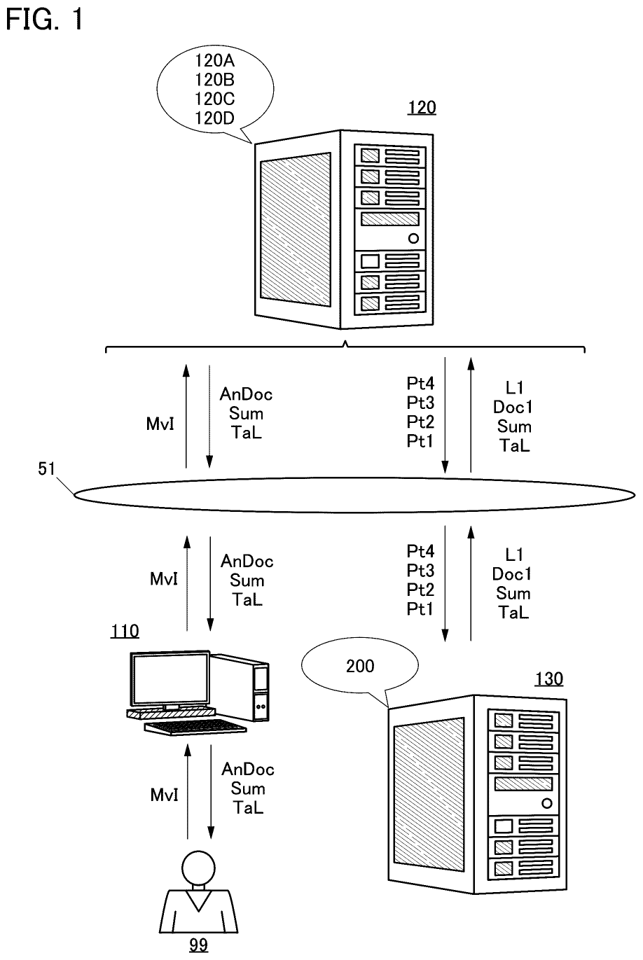

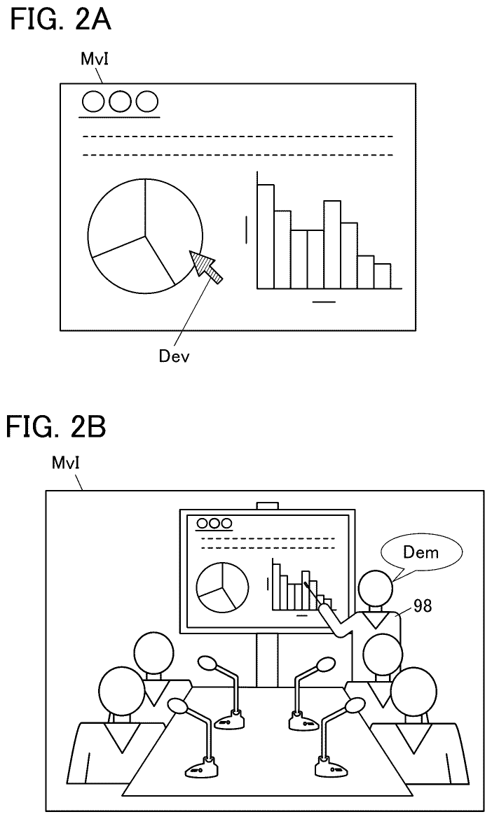

In this embodiment, an information processing system of one embodiment of the present invention will be described. The description is given with reference to FIG. 1, FIGS. 2A and 2B, FIG. 3, FIG. 4, FIGS. 5A and 5B, FIG. 6, FIGS. 7A and 7B, FIGS. 8A and 8B, FIGS. 9A and 9B, FIGS. 10A and 10B, and FIG. 11.

### Configuration Example 1 of Information Processing System

FIG. 1 illustrates a configuration example of the information processing system of one embodiment of the present invention.

The information processing system described in this embodiment includes a component 110, a component 130, and a component 120.

An information processing device having a function of the component 110, an information processing device having a function of the component 130, and an information processing device having a function of the component 120 each include an arithmetic device and a communication device. The communication devices are connected to each other through a network 51, to form the information processing system of one embodiment of the present invention.

### Configuration Example 1 of Component 110

The component 110 has a function of receiving moving image information MvI and transmitting it to the component 120, and a function of receiving an annotated document AnDoc and providing it to a user 99 of the information processing system, for example (see FIG. 1). Specifically, with the use of an output device such as a display device, a speaker, or a printer, the annotated document AnDoc is provided to the user 99 of the information processing system.

### Configuration Example of Moving Image Information MvI

FIG. 2A illustrates an example of the moving image information MvI.

The moving image information MvI includes audio and video. For example, materials and audio displayed on the display device can be recorded to be used as the moving image information MvI. The moving image information MvI sometimes includes a scene in which a demonstrative is spoken while the material is pointed by a pointing device Dev such as a mouse pointer.

For example, the proceedings of a meeting or the like can be recorded with an observation camera to be used as the moving image information MvI. FIG. 2B illustrates an example of the moving image information MvI using the observation camera.

The moving image information MvI sometimes includes a scene in which a speaker 98 speaks a demonstrative while pointing at the material.

The audio of the moving image information MvI sometimes includes a demonstrative that cannot specify its referent. For example, the text in the next paragraph is an example of a speech in a conference. The term “this” in the text is a demonstrative, and the text alone is difficult to specify the referent of the demonstrative.

“In the drawing of the material, this is indicated.”

In this specification, a demonstrative whose referent to be indicated is unclear or hard to be determined from the context is referred to as “a referent-unspecified demonstrative Dem”.

### Configuration Example of Annotated Document AnDoc

The annotated document AnDoc includes a document Doc1(X) created from the moving image information MvI. The document Doc1(X) includes the referent-unspecified demonstrative Dem and an annotation Ano(X). The annotation Ano(X) includes information specified as the referent of the referent-unspecified demonstrative Dem.

### Configuration Example 1 of Component 130

The component 130 has a function of receiving a prompt Pt1 and transmitting a list L1 to the component 120, a function of receiving a prompt Pt2 and transmitting the document Doc1(X) to the component 120, and a function of performing processing with the use of a multimodal AI server 200 (see FIG. 1).

### Configuration Example 1 of Multimodal AI Server 200

The multimodal AI server 200 has a function of generating the list L1 in accordance with the prompt Pt1 and a function of generating the document Doc1(X) in accordance with the prompt Pt2. The prompt Pt1, the prompt Pt2, the list L1, and the document Doc1(X) are created by the component 120 described later.

The multimodal AI server 200 uses a foundation model with the use of artificial intelligence (AI) so that it can be applied across a wide range of tasks. For example, the multimodal AI server 200 can collect information from two or more different kinds of data (text data, audio data, image data, moving image data, and the like) and integrate them to execute processing. The foundation model is an AI model having a function of interpreting at least both language and images to generate language, and the server has a function of converting the different data into a format that the AI model can interpret.

### Configuration Example 1 of Component 120

The component 120 has a function of receiving the moving image information MvI, the list L1, and the document Doc1(X) and sharing them in the component 120 (see FIG. 1), a function of transmitting the prompt Pt1 and the prompt Pt2 to the component 130, and a function of transmitting the annotated document AnDoc to the component 110.

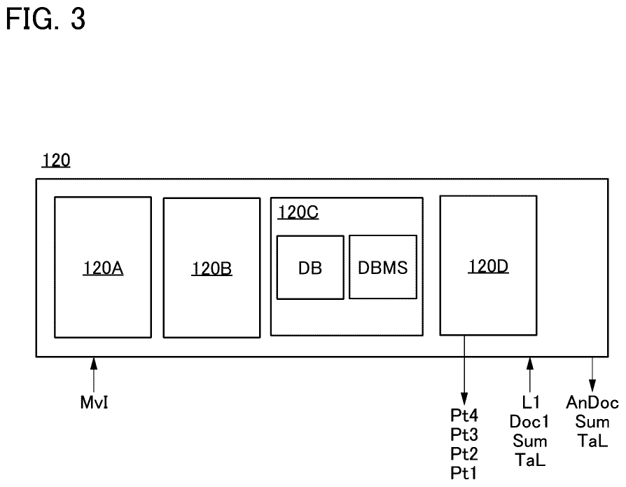

The component 120 includes a subcomponent 120A, a subcomponent 120B, a subcomponent 120C, and a subcomponent 120D. FIG. 3 illustrates a configuration example of the component 120.

### Configuration Example 1 of Subcomponent 120A

The subcomponent 120A has a function of dividing the moving image information MvI to create a group of chunk data ChD (see FIG. 3).

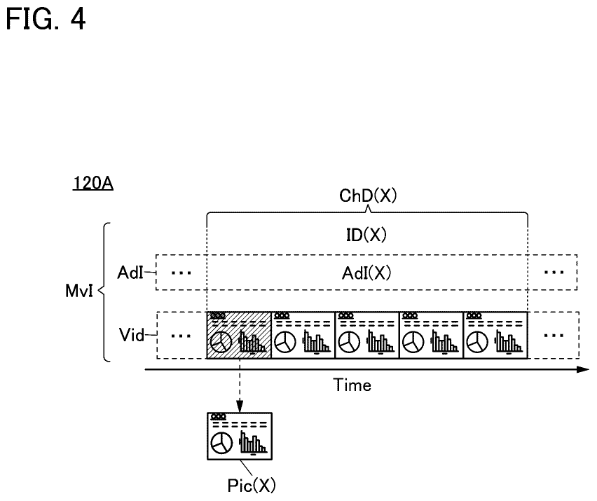

FIG. 4 illustrates the moving image information MvI. The horizontal axis represents time (Time) and audio information AdI and video information Vid at each time are schematically illustrated.

The moving image information MvI includes the audio information AdI and the video information Vid. The moving image information MvI can be divided into the chunk data ChD. The chunk data ChD includes the divided video information Vid. From the divided video information Vid, a still image Pic that represents the chunk data ChD can be extracted. Furthermore, the time (Time) that represents the chunk data ChD can be recorded in the still image Pic.

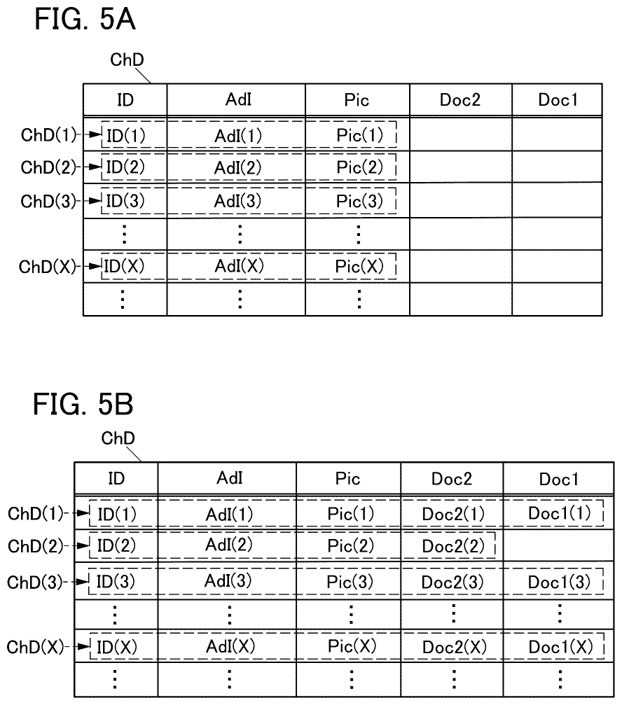

FIG. 5A illustrates a configuration example of the group of the chunk data ChD divided from the moving image information MvI.

The group of the chunk data ChD includes one piece of chunk data ChD(X). In other words, the chunk data ChD(X) is one selected from the group of the chunk data ChD.

The chunk data ChD(X) includes identification information ID(X), audio information AdI(X), and a still image Pic(X). The still image Pic(X) is an image that represents the chunk data ChD(X).

Specifically, chunk data ChD(1) includes identification information ID(1), audio information AdI(1), and a still image Pic(1). The still image Pic(1) is a still image that represents the chunk data ChD(1). Chunk data ChD(2) includes identification information ID(2), audio information AdI(2), and a still image Pic(2). The still image Pic(2) is a still image that represents the chunk data ChD(2). Chunk data ChD(3) includes identification information ID(3), audio information AdI(3), and a still image Pic(3). The still image Pic(3) is a still image that represents the chunk data ChD(3).

### Configuration Example 1 of Subcomponent 120B

The subcomponent 120B has a function of transcribing the audio information AdI(X) into a document Doc2(X). In other words, the subcomponent 120B has a function of creating the document Doc2(X) from the audio information AdI(X) (see FIG. 3).

### Configuration Example 1 of Subcomponent 120C

The subcomponent 120C includes a database DB and a management system DBMS (see FIG. 3).

The database DB has a function of storing the group of the chunk data ChD.

The management system DBMS has a function of integrating the document Doc1(X) into the chunk data ChD(X) and a function of creating the annotated document AnDoc from the database DB (see FIG. 5B).

The management system DBMS has a function of creating the annotated document AnDoc from the group of the chunk data ChD. Specifically, the management system DBMS has a function of creating the annotated document AnDoc by creating documents in which annotations are added as needed for respective chunk data and connecting the documents in the order of their identification information IDs.

For example, in the case where the chunk data ChD(1) needs to be annotated, the management system DBMS creates a document Doc(1) in which an annotation is added. In the case where the chunk data ChD(2) does not need to be annotated, the management system DBMS does not create a document in which an annotation is added. Furthermore, the management system DBMS creates the annotated document AnDoc by connecting a document Doc1(1) linked with the chunk data ChD(1), a document Doc2(2) linked with the chunk data ChD(2), and a document Doc1(3) linked with the chunk data ChD(3) in the order of their identification information IDs. Similarly, the management system DBMS creates the annotated document AnDoc by connecting the document Doc1(X) linked with the chunk data ChD(X) (the document Doc2(X) in the case of the chunk data ChD(2) for which the document Doc1(X) is not created) in the order of their identification information IDs.

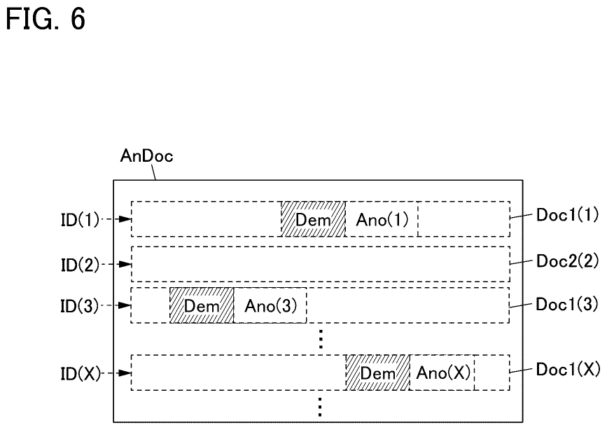

FIG. 6 illustrates an example of the annotated document AnDoc in which the annotations Ano are added to the referent-unspecified demonstratives Dem. The annotation Ano is information that specifies the referent of the referent-unspecified demonstrative Dem.

### Configuration Example 2 of Subcomponent 120C

The subcomponent 120C has a function of sharing a table Tbl1 and a table Tbl2 in the component 120. The management system DBMS has a function of creating the table Tbl1 and the table Tbl2 from the database DB.

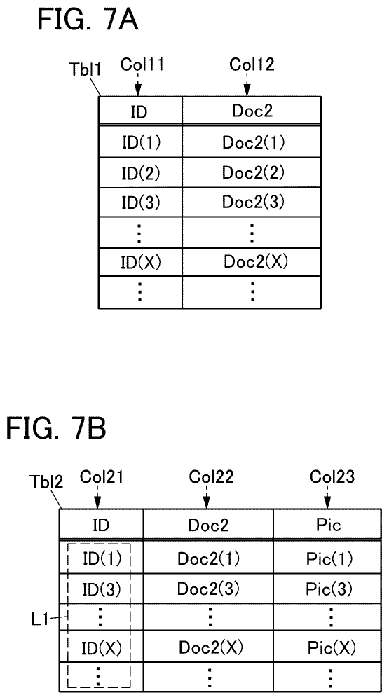

FIG. 7A illustrates an example of the created table Tbl1.

The table Tbl1 includes a column Col11 and a column Col12. The column Col11 includes the identification information ID(X). The column Col12 includes the document Doc2(X).

FIG. 7B illustrates an example of the created table Tbl2.

The table Tbl2 includes a column Col21, a column Col22, and a column Col23. The column Col21 includes the identification information ID(X) included in the list L1. The column Col22 includes the document Doc2(X). The column Col23 includes the still image Pic(X).

### Configuration Example 1 of Subcomponent 120D

The subcomponent 120D has a function of creating the prompt Pt1 and a function of sequentially selecting the identification information ID(X) from the list L1 to create the prompt Pt2 (see FIG. 3).

### Configuration Example of Prompt Pt1

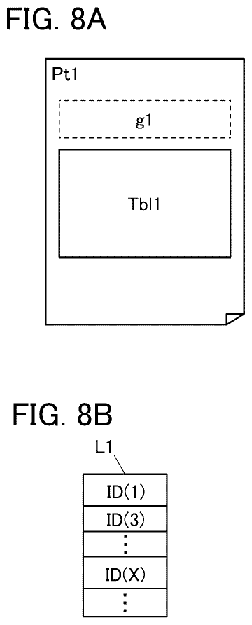

FIG. 8A illustrates a configuration diagram of the prompt Pt1. The prompt Pt1 includes an instruction g1 and the table Tbl1.

The instruction g1 includes a procedure for generating the list L1 from the table Tbl1. The list L1 includes the identification information ID(X) that identifies the document Doc2(X). The document Doc2(X) includes the referent-unspecified demonstrative Dem. In other words, the document Doc2(X) identified by the identification information ID(X) described in the list L1 includes the referent-unspecified demonstrative Dem.

For example, the text in the next paragraph can be used as the prompt Pt1.
“Document: {Table Tbl1}
Link each demonstrative with its referent from the documents included in the above table. If the referent is unknown, create a list of identification information of documents that include demonstratives whose referents are unspecified.”

FIG. 8B illustrates the generated list L1. In the case where the referent-unspecified demonstrative Dem is found, the identification information ID of its chunk is included in the list L1.

Specifically, when the chunk data ChD(1) identified by the identification information ID(1) includes the referent-unspecified demonstrative Dem, the list L1 includes the identification information ID(1). When the chunk data ChD(3) identified by the identification information ID(3) includes the referent-unspecified demonstrative Dem, the list L1 includes the identification information ID(3). When the chunk data ChD(X) identified by the identification information ID(X) includes the referent-unspecified demonstrative Dem, the list L1 includes the identification information ID(X).

### Configuration Example of Prompt Pt2

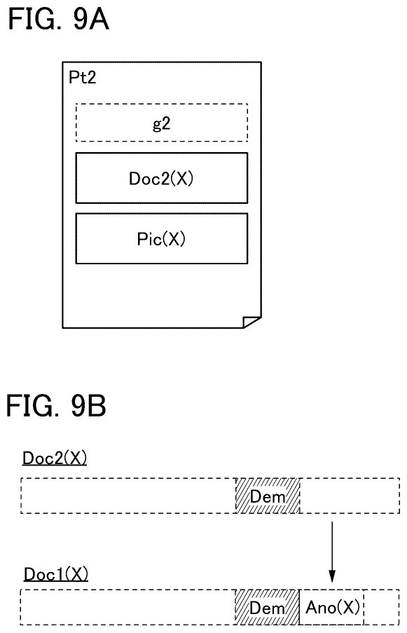

FIG. 9A illustrates a configuration diagram of the prompt Pt2. The prompt Pt2 includes an instruction g2, the document Doc2(X), and the still image Pic(X).

The instruction g2 includes a procedure for specifying, from the still image Pic(X), the referent of the referent-unspecified demonstrative Dem included in the document Doc2(X) and generating the document Doc1(X).

For example, the text in the next paragraph can be used as the prompt Pt2.
“Image: still image Pic(X)
Document: document Doc2(X)
Demonstrative: referent-unspecified demonstrative Dem
Specify and answer the referent of the demonstrative included in the document from the image.”

FIG. 9B illustrates the generated document Doc1(X). The document Doc1(X) is a document in which the annotation Ano(X) is added to the referent-unspecified demonstrative Dem included in the document Doc2(X).

Accordingly, the referent of the referent-unspecified demonstrative Dem included in the audio information AdI(X) can be specified from the still image Pic(X), so that the annotation Ano(X) can be generated. The annotation Ano(X) can be added to the referent-unspecified demonstrative Dem included in the audio information AdI(X). The annotated document AnDoc in which the annotation Ano(X) is added to the audio included in the moving image information MvI can be created. The annotated document AnDoc can be provided to the user of the information processing system, for example. As a result, a novel display device that is highly convenient, useful, or reliable can be provided.

### Configuration Example 2 of Component 110

The component 110 has a function of receiving a summary document Sum and providing it to the user 99 of the information processing system, for example (see FIG. 1). The summary document Sum is a document in which the annotated document AnDoc is summarized.

### Configuration Example 2 of Component 130

The component 130 has a function of performing processing with the use of the multimodal AI server 200 and a function of receiving a prompt Pt3 and transmitting the summary document Sum to the component 120.

### Configuration Example 2 of Multimodal AI Server 200

The multimodal AI server 200 has a function of generating the summary document Sum in accordance with the prompt Pt3.

### Configuration Example 2 of Component 120

The component 120 has a function of transmitting the prompt Pt3 to the component 130 and a function of receiving the summary document Sum and transmitting it to the component 110.

### Configuration Example 3 of Subcomponent 120D

The subcomponent 120D has a function of creating the prompt Pt3.

### Configuration Example of Prompt Pt3

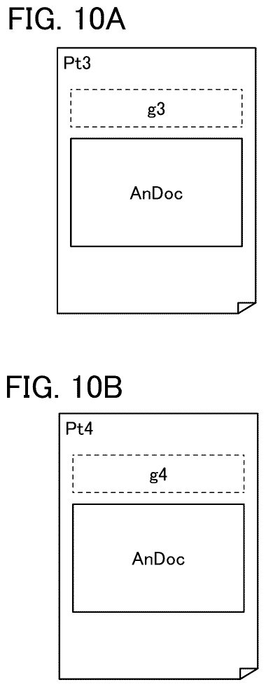

FIG. 10A illustrates a configuration diagram of the prompt Pt3. The prompt Pt3 includes an instruction g3 and the annotated document AnDoc.

The instruction g3 includes a procedure for generating the summary document Sum from the annotated document AnDoc.

For example, the text in the next paragraph can be used as the prompt Pt3.
“document: {Annotated Document Andoc}
Summarize the document.”

Accordingly, the referent of the referent-unspecified demonstrative Dem included in the audio information AdI(X) can be specified from the still image Pic(X), so that the annotation Ano(X) can be generated. The annotation Ano(X) can be added to the referent-unspecified demonstrative Dem included in the audio information AdI(X). The annotated document AnDoc in which the annotation Ano(X) is added to the audio included in the moving image information MvI can be created. The summary document Sum can be generated from the annotated document AnDoc. The summary document Sum can be provided to the user of the information processing system, for example. As a result, a novel display device that is highly convenient, useful, or reliable can be provided.

### Configuration Example 3 of Component 110

The component 110 has a function of receiving the task list TaL and providing it to the user 99 of the information processing system, for example (see FIG. 1). The task list TaL is a list summarizing tasks. Specifically, the task list TaL is a list in which texts with predetermined deadlines are extracted using the annotated document AnDoc and the task contents, priorities, deadlines, and the like are summarized.

### Configuration Example 3 of Component 130

The component 130 has a function of performing processing with the use of the multimodal AI server 200 and a function of receiving a prompt Pt4 and transmitting the task list TaL to the component 120.

### Configuration Example 3 of Multimodal AI Server 200

The multimodal AI server 200 has a function of generating the task list TaL in accordance with the prompt Pt4.

### Configuration Example 3 of Component 120

The component 120 has a function of transmitting the prompt Pt4 to the component 130 and a function of receiving a task list TaL and transmitting it to the component 110.

### Configuration Example 4 of Subcomponent 120D

The subcomponent 120D has a function of creating the prompt Pt4.

### Configuration Example of Prompt Pt4

FIG. 10B illustrates a configuration diagram of the prompt Pt4. The prompt Pt4 includes an instruction g4 and the annotated document AnDoc.

The instruction g4 includes a procedure for generating the task list TaL from the annotated document AnDoc.

For example, the text in the next paragraph can be used as the prompt Pt4.
“Document: {annotated document AnDoc}
Create a task list from the document.”

Accordingly, the referent of the referent-unspecified demonstrative Dem included in the audio information AdI(X) can be specified from the still image Pic(X), so that the annotation Ano(X) can be generated. The annotation Ano(X) can be added to the referent-unspecified demonstrative Dem included in the audio information AdI(X). The annotated document AnDoc in which the annotation Ano(X) is added to the audio included in the moving image information MvI can be created. The task list TaL can be generated from the annotated document AnDoc. The task list TaL can be provided to the user of the information processing system, for example. As a result, a novel display device that is highly convenient, useful, or reliable can be provided.

### Configuration Example 2 of Information Processing System

FIG. 1 illustrates a configuration example of the information processing system of one embodiment of the present invention.

Another information processing system described in this embodiment includes the component 110, the component 120, and the component 130.

The information processing system of one embodiment of the present invention can be composed of an information processing device having a function of the component 110, an information processing device having a function of the component 120, and an information processing device having a function of the component 130, for example. Note that the number of information processing devices constituting the information processing system of one embodiment of the present invention is one or more. For example, a plurality of information processing devices can be connected to each other using the network 51 to construct the information processing system of one embodiment of the present invention.

When the information processing system of one embodiment of the present invention is constituted with the plurality of information processing devices, loads relating to information processing can be dispersed.

### Configuration Example 1 of Information Processing Device

A configuration example 1 of the information processing device described in this embodiment can be used as the component 110. The configuration example 1 of the information processing device can be referred to as a client computer or the like. For example, a desktop computer can be used as the component 110.

The configuration example 1 of the information processing device can receive data input by the user of the information processing system of one embodiment of the present invention. The configuration example 1 of the information processing device can provide data output from the information processing system of one embodiment of the present invention to the user.

For example, dedicated application software or a web browser operates in the component 110. Via either of them, the user of the information processing system of one embodiment of the present invention can access the information processing system. Thus, the user can receive service using the information processing system of one embodiment of the present invention.

### Configuration Example 2 of Information Processing Device

A configuration example 2 of the information processing device described in this embodiment can be used as the component 120. For example, a workstation, a server computer, or a supercomputer can be used as the component 120.

The configuration example 2 of the information processing device preferably has a function of a parallel computer. When the information processing device with this configuration is used as a parallel computer, large-scale computation necessary for artificial intelligence (AI) learning and inference can be performed, for example.

Furthermore, the configuration example 2 of the information processing device can perform processing utilizing a large language model with the use of AI.

For example, processing with the use of a natural language model such as GPT-3 (registered trademark), GPT-3.5, GPT-4 (registered trademark), LaMDA, Llama2, Llama3, Llama3.2, or Llama3.3 is preferably executed.

### Configuration Example 3 of Information Processing Device

A configuration example 3 of the information processing device described in this embodiment can be used as the component 130. Note that the component 130 has a larger scale and higher computational capability than the component 120. For example, a workstation, a server computer, or a supercomputer can be used as the component 130.

The configuration example 3 of the information processing device preferably has a function of a parallel computer. When the information processing device with this configuration is used as a parallel computer, large-scale computation necessary for AI learning and inference can be performed, for example.

Furthermore, the configuration example 3 of the information processing device can perform processing utilizing a foundation model with the use of AI.

For example, processing with the use of a foundation model such as GPT-3 (registered trademark), GPT-3.5, GPT-4 (registered trademark), LaMDA, Llama2, Llama3, Llama3.2, or Llama3.3 can be executed. In particular, processing with the use of GPT-4 (registered trademark) is preferably executed.

Note that a service provider using the information processing system of one embodiment of the present invention does not necessarily have its own configuration example 3 of the information processing device. For example, a service provider can utilize part of the service that another company or the like provides using the configuration example 3 of the information processing device.

### Configuration Example of Network 51

The network 51 that can be used for the information processing system of one embodiment of the present invention can connect the plurality of information processing devices to each other. Thus, the plurality of information processing devices connected to each other can transmit and receive data to and from each other. Furthermore, loads of the information processing can be dispersed.

Note that for wireless communication, it is possible to use, as a communication protocol or a communication technology, a communication standard such as the fourth-generation mobile communication system (4G), the fifth-generation mobile communication system (5G), or the sixth-generation mobile communication system (6G), or a communication standard developed by IEEE such as Wi-Fi (registered trademark) or Bluetooth (registered trademark).

For example, a local network can be used as the network 51. An intranet or an extranet can also be used as the network 51. For another example, a personal area network (PAN), a local area network (LAN), a campus area network (CAN), a metropolitan area network (MAN), a wide area network (WAN), or a global area network (GAN) can be used as the network 51.

For example, a global network can be used as the network 51. Specifically, the Internet, which is an infrastructure of the World Wide Web (WWW), can be used.

Furthermore, the service provider using the information processing system of one embodiment of the present invention can provide service using the information processing method of one embodiment of the present invention via the network 51, for example.

Note that in the case where the information processing system of one embodiment of the present invention is constructed in a local network, the possibility of leakage of confidential information can be lower than that in the case of utilizing the Internet, for example.

### Configuration Example 4 of Information Processing Device

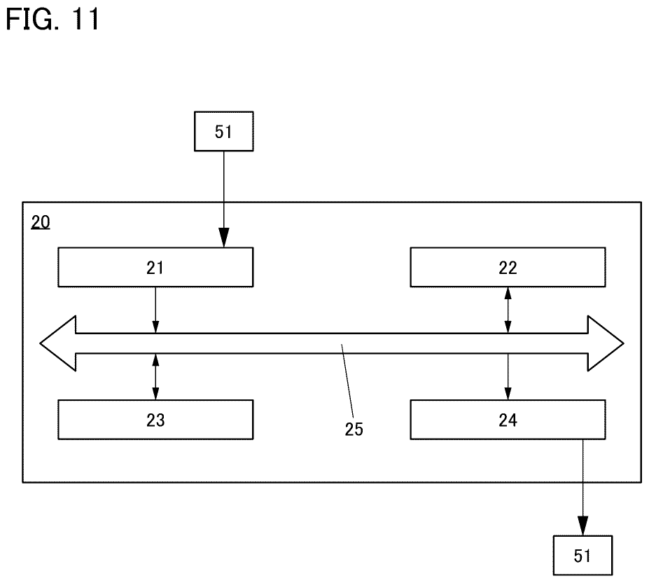

FIG. 11 is a block diagram illustrating a configuration example of the information processing device of one embodiment of the present invention.

An information processing device 20 that can be used for the information processing system of one embodiment of the present invention includes, for example, an input unit 21, a storage unit 22, a processing unit 23, an output unit 24, and a transmission path 25.

Although the block diagram in drawings attached to this specification illustrates components classified by their functions in independent blocks, it is difficult to classify actual components by their functions completely, and one component can have a plurality of functions. For example, part of the processing unit 23 functions as the input unit 21 in some cases. In addition, one function can be involved in a plurality of components. For example, processing performed in the processing unit 23 is sometimes executed by a different information processing device depending on the processing.

### Input Unit 21

The input unit 21 can receive data from the outside of the information processing device. For example, the input unit 21 receives data via the network 51. Specifically, a device such as a personal computer having a communication port or a communication function can be used.

The input unit 21 supplies the received data to one or both of the storage unit 22 and the processing unit 23 via the transmission path 25.

### Storage Unit 22

The storage unit 22 has a function of storing a program to be executed by the processing unit 23. The storage unit 22 can also have a function of storing data generated by the processing unit 23 (e.g., an arithmetic operation result, an analysis result, or an inference result), data received by the input unit 21, and the like.

The storage unit 22 can include a database. The information processing device can include a database in addition to the storage unit 22. The information processing device can have a function of extracting data from a database outside the storage unit 22, the information processing device, or the information processing system. Alternatively, the information processing device can have a function of extracting data from both of its own database and an external database.

One or both of a storage and a file server can be used as the storage unit 22. In addition, a database in which a path of a file stored in the file server is recorded can be used as the storage unit 22.

The storage unit 22 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase change random access memory (PRAM), a ferroelectric random access memory (FeRAM), a magnetoresistive random access memory (MRAM, also referred to as a magnetoresistive memory), and a flash memory. The storage unit 22 can include at least one of a NOSRAM (registered trademark) and a DOSRAM (registered trademark). The storage unit 22 can include a storage media drive. Examples of the storage media drive include a hard disk drive (HDD) and a solid state drive (SSD).

Note that the NOSRAM is an abbreviation for “nonvolatile oxide semiconductor random access memory (RAM)”. The NOSRAM refers to a memory in which a two-transistor (2T) or three-transistor (3T) gain cell is used as a memory cell and the transistor includes a metal oxide in its channel formation region (such a transistor is also referred to as an OS transistor). The OS transistor has an extremely low current that flows between a source and a drain in an off state, that is, an extremely low leakage current. The NOSRAM retains electric charge corresponding to data in memory cells by using characteristics of extremely low leakage current, thereby capable of being used as a nonvolatile memory. In particular, the NOSRAM is capable of reading retained data without destruction (non-destructive reading), and thus is suitable for arithmetic processing in which only data reading operations are repeated many times. The NOSRAM can have large data capacity when stacked in layers, and thus, a semiconductor device in which the NOSRAM is used for a large-scale cache memory, a large-scale main memory, or a large-scale storage memory can have higher performance.

A DRAM refers to a Random Access Memory (RAM) including a one-transistor (1T) and one-capacitor (1C) memory cell. The DOSRAM is an abbreviation for “dynamic oxide semiconductor RAM”. The DOSRAM is a DRAM formed using an OS transistor and temporarily stores information sent from the outside. The DOSRAM is a memory utilizing a low off-state current of an OS transistor, which can inhibit data deterioration due to the off-state current and retain data for a long time. This enables the reduced number of times of data refresh and consequently, using the DOSRAM can reduce the power consumption.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably contains indium (In). When the metal oxide included in the channel formation region is a metal oxide containing indium, the carrier mobility (electron mobility) of the OS transistor is high. For example, indium oxide (InOx) or indium gallium zinc oxide (In-Ga-Zn oxide, also referred to as “IGZO”) can be used for the channel formation region. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than indium is. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The metal oxide in the channel formation region may be, for example, a metal oxide that does not contain indium but contains any of zinc, gallium, and tin (e.g., zinc tin oxide and gallium tin oxide).

### Processing Unit 23

The processing unit 23 has a function of performing processing such as arithmetic operation, analysis, and inference with the use of data supplied from one or both of the input unit 21 and the storage unit 22. The processing unit 23 can supply generated data (e.g., an arithmetic operation result, an analysis result, or an inference result) to one or both of the storage unit 22 and the output unit 24.

The processing unit 23 has a function of obtaining data from the storage unit 22. The processing unit 23 can also have a function of storing or registering data in the storage unit 22.

The processing unit 23 can include an arithmetic circuit, for example. The processing unit 23 can include, for example, a central processing unit (CPU). The processing unit 23 can also include a graphics processing unit (GPU). Furthermore, the processing unit 23 can include a neural processing unit/neural network processing unit (NPU).

The processing unit 23 can include a microprocessor such as a digital signal processor (DSP). The microprocessor can be achieved with a programmable logic device (PLD) such as a field programmable gate array (FPGA) or a field programmable analog array (FPAA). The processing unit 23 can also include a quantum processor. The processing unit 23 can interpret and execute instructions from various programs with the use of a processor to process various kinds of data and control programs. The programs to be executed by the processor are stored in at least one of the storage unit 22 and a memory region of the processor.

The processing unit 23 can include a main memory. The main memory includes at least one of a volatile memory such as a RAM and a nonvolatile memory such as a read only memory (ROM). The main memory can include at least one of the above-described NOSRAM and DOSRAM.

Examples of the RAM include a DRAM and an SRAM; a virtual memory space is assigned and utilized as a working space of the processing unit 23. An operating system, an application program, a program module, program data, a look-up table, and the like which are stored in the storage unit 22 are loaded into the RAM for execution. The data, program, and program module which are loaded into the RAM are each directly accessed and operated by the processing unit 23.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

The processing unit 23 can include one or both of an OS transistor and a transistor including silicon in its channel formation region (Si transistor).

The processing unit 23 preferably includes an OS transistor. Since the OS transistor has an extremely low off-state current, a long data retention period can be ensured with the use of the OS transistor as a switch for retaining electric charge (data) that has flowed into a capacitor functioning as a memory element. When this feature is imparted to at least one of a register and a cache memory included in the processing unit, the processing unit can be operated only when needed, and otherwise can be off while information processed immediately before turning off the processing unit is stored in the memory element. In other words, normally-off computing is possible and the power consumption of the information processing system can be reduced.

The information processing device preferably uses AI for at least part of its processing.

In particular, the information processing device preferably uses an artificial neural network (ANN, hereinafter also simply referred to as a neural network). The neural network can be constructed with circuits (hardware) or programs (software).

In this specification and the like, the neural network indicates a general model having the capability of solving problems, which is modeled on a biological neural network and determines the connection strength of neurons by learning. The neural network includes an input layer, an intermediate layer (hidden layer), and an output layer.

In the description of the neural network in this specification and the like, determining a connection strength of neurons (also referred to as weight coefficients) from the existing information is referred to as “learning” in some cases.

In this specification and the like, drawing a new conclusion from a neural network formed with the connection strength obtained by learning is referred to as “inference” in some cases.

### Output Unit 24

The output unit 24 can output at least one of an arithmetic operation result, an analysis result, and an inference result in the processing unit 23 to the outside of the information processing device. For example, the output unit 24 can transmit data via the network 51. Specifically, a device such as a personal computer having a communication port or a communication function can be used. Furthermore, a device having a communication function may be used as the input unit 21 and the output unit 24.

### Transmission Path 25

The transmission path 25 has a function of transmitting data. Data transmission and reception between the input unit 21, the storage unit 22, the processing unit 23, and the output unit 24 can be performed via the transmission path 25. Specifically, a LAN or the Internet can be used.

Note that this embodiment can be combined with any of the other embodiments in this specification as appropriate.

### Embodiment 2

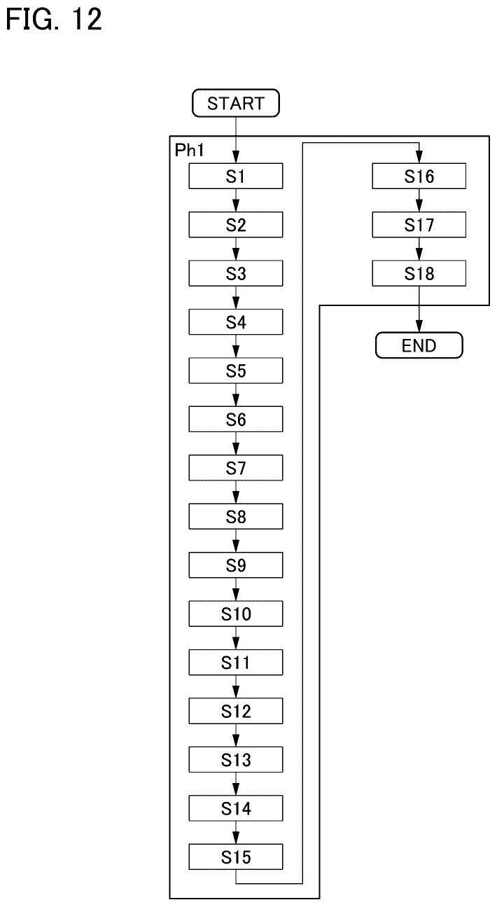

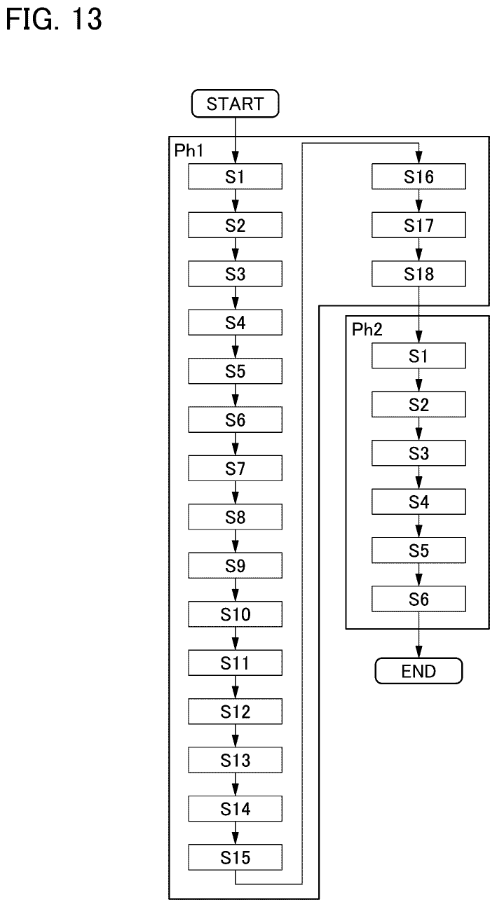

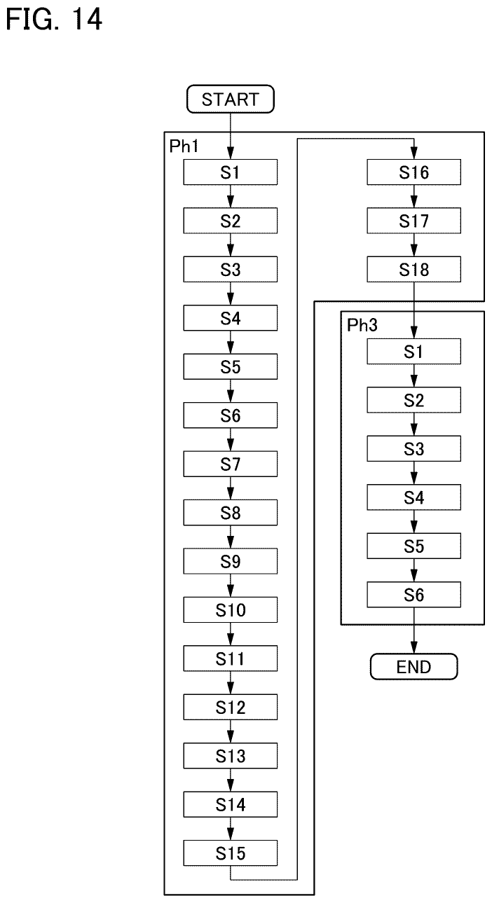

In this embodiment, the information processing method of one embodiment of the present invention will be described. The description is given with reference to flow diagrams in FIG. 12, FIG. 13, and FIG. 14.

### Example 1 of Information Processing Method

FIG. 12 is a flow diagram showing the information processing method of one embodiment of the present invention.

The information processing method of one embodiment of the present invention includes a phase Ph1.

### Example of Phase Ph1

The phase Ph1 includes a step S1 to a step S18.

### Step S1

In the step S1 of the phase Ph1, the component 110 receives the moving image information MvI and transmits it to the component 120.

The component 120 includes the subcomponent 120A, the subcomponent 120B, the subcomponent 120C, and the subcomponent 120D.

### Step S2

In the step S2 of the phase Ph1, the component 120 receives the moving image information MvI and shares it in the component 120.

### Step S3

In the step S3 of the phase Ph1, the subcomponent 120A divides the moving image information MvI to create the group of the chunk data ChD. The group of the chunk data ChD includes the chunk data ChD(X).

The chunk data ChD(X) includes the identification information ID(X), the audio information AdI(X), and the still image Pic(X). The still image Pic(X) is an image that represents the chunk data ChD(X).

### Step S4

In the step S4 of the phase Ph1, the subcomponent 120B transcribes the audio information AdI(X) into the document Doc2(X).

### Step S5

In the step S5 of the phase Ph1, the subcomponent 120C integrates the document Doc2(X) into the chunk data ChD(X) with the use of the management system DBMS.

The subcomponent 120C includes the database DB and the management system DBMS.

### Step S6

In the step S6 of the phase Ph1, the management system DBMS creates the table Tbl1 from the database DB and shares the table Tbl1 in the component 120.

The table Tbl1 includes the column Col11 and the column Col12. The column Col11 includes the identification information ID(X). The column Col12 includes the document Doc2(X).

### Step S7

In the step S7 of the phase Ph1, the subcomponent 120D creates the prompt Pt1 and transmits it to the component 130.

The prompt Pt1 includes the instruction g1 and the table Tbl1. The instruction g1 includes a procedure for generating the list L1 from the table Tbl1. The list L1 includes the identification information ID(X) that identifies the document Doc2(X). The document Doc2(X) includes the referent-unspecified demonstrative Dem.

### Step S8

In the step S8 of the phase Ph1, the component 130 receives the prompt Pt1 and generates the list L1 with the use of the multimodal AI server 200.

### Step S9

In the step S9 of the phase Ph1, the component 130 transmits the list L1 to the component 120.

### Step S10

In the step S10 of the phase Ph1, the component 120 receives the list L1 and shares it in the component 120.

### Step S11

In the step S11 of the phase Ph1, the management system DBMS creates the table Tbl2 from the database DB and shares the table Tbl2 in the component 120.

Note that the table Tbl2 includes the column Col21, the column Col22, and the column Col23. The column Col21 includes the identification information ID included in the list L1. The column Col22 includes the document Doc2(X). The column Col23 includes the still image Pic(X).

### Step S12

In the step S12 of the phase Ph1, the subcomponent 120D sequentially selects a record from the table Tbl2 to create a prompt Pt2(X) and transmits it to the component 130.

The prompt Pt2(X) includes the instruction g2, the document Doc2(X), and the still image Pic(X). The instruction g2 includes a procedure for specifying, from the still image Pic(X), the referent of the referent-unspecified demonstrative Dem included in the document Doc2(X) and generating the document Doc1(X). The document Doc1(X) includes the referent-unspecified demonstrative Dem and the annotation Ano(X).

The annotation Ano(X) includes information specified as the referent of the referent-unspecified demonstrative Dem.

### Step S13

In the step S13 of the phase Ph1, the component 130 receives the prompt Pt2 and generates the document Doc1(X) with the use of the multimodal AI server 200.

### Step S14

In the step S14 of the phase Ph1, the component 130 transmits the document Doc1(X) to the component 120.

### Step S15

In the step S15 of the phase Ph1, the component 120 receives the document Doc1(X) and shares it in the component 120.

### Step S16

In the step S16 of the phase Ph1, the management system DBMS integrates the document Doc1(X) into the chunk data ChD(X).

### Step S17

In the step S17 of the phase Ph1, the management system DBMS creates the annotated document AnDoc from the database DB and transmits it to the component 110.

The annotated document AnDoc includes the document Doc1(X) created from the moving image information MvI. In other words, the annotated document AnDoc is a document in which the audio information AdI and the video information Vid are transcribed.

### Step S18

In the step S18 of the phase Ph1, the component 110 receives the annotated document AnDoc and provides it to the user 99 of the information processing system, for example.

Accordingly, the referent of the referent-unspecified demonstrative Dem included in the audio information AdI(X) can be specified from the still image Pic(X), so that the annotation Ano(X) can be generated. The annotation Ano(X) can be added to the referent-unspecified demonstrative Dem included in the audio information AdI(X). The annotated document AnDoc in which the annotation Ano(X) is added to the audio included in the moving image information MvI can be created. The annotated document AnDoc can be provided to the user of the information processing system, for example. As a result, a novel display device that is highly convenient, useful, or reliable can be provided. With the use of the information processing system of one embodiment of the present invention, a document (e.g., a conversation record) with few unclear descriptions can be created on the basis of the moving image information. In addition, a document having the demonstratives whose referents are clear can be created.

### Example 2 of Information Processing Method

FIG. 13 is a flow diagram showing the information processing method of one embodiment of the present invention.

The information processing method of one embodiment of the present invention includes a phase Ph2.

### Example of Phase Ph2

The phase Ph2 follows the phase Ph1, and the phase Ph2 includes the step S1 to the step S6.

### Step S1

In the step S1 of the phase Ph2, the subcomponent 120D creates the prompt Pt3 and transmits it to the component 130.

The prompt Pt3 includes the instruction g3 and the annotated document AnDoc. The instruction g3 includes a procedure for generating the summary document Sum from the annotated document AnDoc.

### Step S2

In the step S2 of the phase Ph2, the component 130 receives the prompt Pt3 and generates the summary document Sum with the use of the multimodal AI server 200.

### Step S3

In the step S3 of the phase Ph2, the component 130 transmits the summary document Sum to the component 120.

### Step S4

In the step S4 of the phase Ph2, the component 120 receives the summary document Sum and shares it in the component 120.

### Step S5

In the step S5 of the phase Ph2, the component 120 transmits the summary document Sum to the component 110.

### Step S6

In the step S6 of the phase Ph2, the component 110 receives the summary document Sum and provides it to the user 99 of the information processing system, for example.

Accordingly, the referent of the referent-unspecified demonstrative Dem included in the audio information AdI(X) can be specified from the still image Pic(X), so that the annotation Ano(X) can be generated. The annotation Ano(X) can be added to the referent-unspecified demonstrative Dem included in the audio information AdI(X). The annotated document AnDoc in which the annotation Ano(X) is added to the audio included in the moving image information MvI can be created. The summary document Sum can be generated from the annotated document AnDoc. The summary document Sum can be provided to the user of the information processing system, for example. As a result, a novel display device that is highly convenient, useful, or reliable can be provided.

### Example 3 of Information Processing Method

FIG. 14 is a flow diagram showing the information processing method of one embodiment of the present invention.

The information processing method of one embodiment of the present invention includes a phase Ph3.

### Example of Phase Ph3

The phase Ph3 follows the phase Ph1, and the phase Ph3 includes the step S1 to the step S6. Note that in the information processing method of one embodiment of the present invention, one or both of the phase Ph2 and the phase Ph3 can be performed after the phase Ph1. The order of the phase Ph2 and the phase Ph3 is not limited. The phase Ph2 and the phase Ph3 may be performed in parallel.

### Step S1

In the step S1 of the phase Ph3, the subcomponent 120D creates the prompt Pt4 and transmits it to the component 130.

The prompt Pt4 includes the instruction g4 and the annotated document AnDoc. The instruction g4 includes a procedure for generating the task list TaL from the annotated document AnDoc.

### Step S2

In the step S2 of the phase Ph3, the component 130 receives the prompt Pt4 and generates the task list TaL with the use of the multimodal AI server 200.

### Step S3

In the step S3 of the phase Ph3, the component 130 transmits the task list TaL to the component 120.

### Step S4

In the step S4 of the phase Ph3, the component 120 receives the task list TaL and shares it.

### Step S5

In the step S5 of the phase Ph3, the component 120 transmits the task list TaL to the component 110.

### Step S6

In the step S6 of the phase Ph3, the component 110 receives the task list TaL and provides it to the user 99 of the information processing system, for example.

Accordingly, the referent of the referent-unspecified demonstrative Dem included in the audio information AdI(X) can be specified from the still image Pic(X), so that the annotation Ano(X) can be generated. The annotation Ano(X) can be added to the referent-unspecified demonstrative Dem included in the audio information AdI(X). The annotated document AnDoc in which the annotation Ano(X) is added to the audio included in the moving image information MvI can be created. The task list TaL can be generated from the annotated document AnDoc. The task list TaL can be provided to the user of the information processing system, for example. As a result, a novel display device that is highly convenient, useful, or reliable can be provided.

This application is based on Japanese Patent Application Serial No. 2024-225325 filed with Japan Patent Office on Dec. 20, 2024, the entire contents of which are hereby incorporated by reference.

What is claimed is:

1. An information processing system comprising:
a first component;
a second component; and
a third component,
wherein the first component is configured to receive moving image information and an annotated document comprising a first document created from the moving image information,
wherein the first document comprises a demonstrative whose referent is unspecified and an annotation comprising information specified as a referent of the demonstrative,
wherein the second component is configured to receive a first prompt comprising a first instruction and a first table and transmit a list generated by a multimodal AI server in accordance with the first prompt to the third component and to receive a second prompt and transmit the first document generated by the multimodal AI server in accordance with the second prompt to the third component,
wherein the third component is configured to receive the moving image information, the list, and the first document, to transmit the first prompt and the second prompt to the second component, and to transmit the annotated document to the first component,
wherein the third component comprises a first subcomponent configured to divide the moving image information to create a group of chunk data comprising identification information, audio information, and a still image, a second subcomponent configured to transcribe the audio information into a second document, a third subcomponent comprising a database configured to store the group of chunk data and a management system configured to create the annotated document from the database, and a fourth subcomponent configured to create the first prompt and to sequentially select the identification information from the list to create the second prompt,
wherein the first instruction comprises a procedure for generating the list from the first table,
wherein the list comprises the identification information that identifies the second document comprising the demonstrative,
wherein the second prompt comprises a second instruction, the second document, and the still image, and
wherein the second instruction comprises a procedure for specifying, from the still image, the referent of the demonstrative included in the second document and generating the first document.

2. The information processing system according to claim 1,
wherein the management system is configured to create the first table and a second table from the database,
wherein the first table comprises a first column and a second column,
wherein the first column comprises the identification information,
wherein the second column comprises the second document,
wherein the second table comprises a third column, a fourth column, and a fifth column,
wherein the third column comprises the identification information included in the list,
wherein the fourth column comprises the second document, and
wherein the fifth column comprises the still image.

3. The information processing system according to claim 2,
wherein the first component is configured to receive a summary document and provide the summary document,
wherein the second component is configured to receive a third prompt and transmit the summary document to the third component,
wherein the multimodal AI server is configured to generate the summary document in accordance with the third prompt,
wherein the third component is configured to transmit the third prompt to the second component and to receive the summary document and transmit the summary document to the first component,
wherein the fourth subcomponent is configured to create the third prompt,
wherein the third prompt comprises a third instruction and the annotated document, and
wherein the third instruction comprises a procedure for generating the summary document from the annotated document.

4. The information processing system according to claim 2,
wherein the first component is configured to receive a task list and provide the task list,
wherein the second component is configured to receive a fourth prompt and transmit the task list to the third component,
wherein the multimodal AI server is configured to generate the task list in accordance with the fourth prompt,
wherein the third component is configured to transmit the fourth prompt to the second component and to receive the task list and transmit the task list to the first component,
wherein the fourth subcomponent is configured to create the fourth prompt,
wherein the fourth prompt comprises a fourth instruction and the annotated document, and
wherein the fourth instruction comprises a procedure for generating the task list from the annotated document.

5. An information processing method comprising a first phase,
wherein the first phase comprises a first step, a second step, a third step, a fourth step, a fifth step, a sixth step, a seventh step, an eighth step, a ninth step, a tenth step, an eleventh step, a twelfth step, a thirteenth step, a fourteenth step, a fifteenth step, a sixteenth step, a seventeenth step, and an eighteenth step,
wherein in the first step of the first phase, a first component receives moving image information and transmits the moving image information to a second component,
wherein the second component comprises a first subcomponent, a second subcomponent, a third subcomponent, and a fourth subcomponent,
wherein the third subcomponent comprises a database and a management system,
wherein in the second step of the first phase, the second component receives the moving image information and shares the moving image information in the second component,
wherein in the third step of the first phase, the first subcomponent divides the moving image information to create a group of chunk data,
wherein the group of chunk data comprises chunk data,
wherein the chunk data comprises identification information, audio information, and a still image,
wherein the still image is an image that represents the chunk data,
wherein in the fourth step of the first phase, the second subcomponent transcribes the audio information into a first document,
wherein in the fifth step of the first phase, the third subcomponent integrates the first document into the chunk data with the use of the management system,
wherein in the sixth step of the first phase, the management system creates a first table from the database and shares the first table in the second component,
wherein the first table comprises a first column and a second column,
wherein the first column comprises the identification information,
wherein the second column comprises the first document,
wherein in the seventh step of the first phase, the fourth subcomponent creates a first prompt and transmits the first prompt to a third component,
wherein the first prompt comprises a first instruction and the first table,
wherein the first instruction comprises a procedure for generating a list from the first table,
wherein the list comprises the identification information that identifies the first document comprising a demonstrative whose referent is unspecified,
wherein in the eighth step of the first phase, the third component receives the first prompt and generates the list with the use of a multimodal AI server,
wherein in the ninth step of the first phase, the third component transmits the list to the second component,
wherein in the tenth step of the first phase, the second component receives the list and shares the list in the second component,
wherein in the eleventh step of the first phase, the management system creates a second table from the database and shares the second table in the second component,
wherein the second table comprises a third column, a fourth column, and a fifth column,
wherein the third column comprises the identification information included in the list,
wherein the fourth column comprises the first document,
wherein the fifth column comprises the still image,
wherein in the twelfth step of the first phase, the fourth subcomponent sequentially selects a record from the second table to create a second prompt and transmits the second prompt to the third component,
wherein the second prompt comprises a second instruction, the first document, and the still image,
wherein the second instruction comprises a procedure for specifying, from the still image, a referent of the demonstrative whose referent is unspecified included in the first document and generating a second document,
wherein the second document comprises the demonstrative whose referent is unspecified and an annotation,
wherein the annotation comprises information specified as the referent of the demonstrative whose referent is unspecified,
wherein in the thirteenth step of the first phase, the third component receives the second prompt and generates the second document with the use of the multimodal AI server,
wherein in the fourteenth step of the first phase, the third component transmits the second document to the second component,
wherein in the fifteenth step of the first phase, the second component receives the second document and shares the second document in the second component,
wherein in the sixteenth step of the first phase, the management system integrates the second document into the chunk data,
wherein in the seventeenth step of the first phase, the management system creates an annotated document from the database and transmits the annotated document to the first component,
wherein the annotated document comprises the second document created from the moving image information, and
wherein in the eighteenth step of the first phase, the first component receives the annotated document and provides the annotated document.

6. The information processing method according to claim 5, further comprising a second phase,
wherein the second phase follows the first phase,
wherein the second phase comprises a first step, a second step, a third step, a fourth step, a fifth step, and a sixth step,
wherein in the first step of the second phase, the fourth subcomponent creates a third prompt and transmits the third prompt to the third component,
wherein the third prompt comprises a third instruction and the annotated document,
wherein the third instruction comprises a procedure for generating a summary document from the annotated document,
wherein in the second step of the second phase, the third component receives the third prompt and generates the summary document with the use of the multimodal AI server,
wherein in the third step of the second phase, the third component transmits the summary document to the second component,
wherein in the fourth step of the second phase, the second component receives the summary document and shares the summary document in the second component,
wherein in the fifth step of the second phase, the second component transmits the summary document to the first component, and
wherein in the sixth step of the second phase, the first component receives the summary document and provides the summary document.

7. The information processing method according to claim 5, further comprising a third phase,
wherein the third phase follows the first phase,
wherein the third phase comprises a first step, a second step, a third step, a fourth step, a fifth step, and a sixth step,
wherein in the first step of the third phase, the fourth subcomponent creates a fourth prompt and transmits the fourth prompt to the third component,
wherein the fourth prompt comprises a fourth instruction and the annotated document,
wherein the fourth instruction comprises a procedure for generating a task list from the annotated document,
wherein in the second step of the third phase, the third component receives the fourth prompt and generates the task list with the use of the multimodal AI server,
wherein in the third step of the third phase, the third component transmits the task list to the second component,
wherein in the fourth step of the third phase, the second component receives the task list and shares the task list in the second component,
wherein in the fifth step of the third phase, the second component transmits the task list to the first component, and
wherein in the sixth step of the third phase, the first component receives the task list and provides the task list.
